(19) United States
(12) Patent Application Publication
(10) Pub. No.: US 2018/0006329 A1
(43) Pub. Date: Jan. 4, 2018

(54) ELECTROCHEMICAL CELLS THAT INCLUDE LEWIS ACID: LEWIS BASE COMPLEX ELECTROLYTE ADDITIVES

(71) Applicant: 3M INNOVATIVE PROPERTIES COMPANY, St. Paul, MN (US)

(72) Inventors: Ang Xiao, Woodbury, MN (US); William M. Lamanna, Stillwater, MN (US); Jeffrey R. Dahn, Nova Scotia (CA); Mengyun Nie, Waltham, MA (US); Kiah A. Smith, Mahtomedi, MN (US); Vincent J. Chevrier, St. Paul, MN (US)

(21) Appl. No.: 15/547,596

(22) PCT Filed: Jan. 29, 2016
(86) PCT No.: PCT/US16/15518

§ 371 Date: Jul. 31, 2017

Related U.S. Application Data
(60) Provisional application No. 62/111,804, filed on Feb. 4, 2015.

(51) Int. Cl. H01M 10/0567; H01M 10/0525; H01M 10/0568; H01M 10/0569

(52) U.S. Cl. CPC H01M 10/0567; H01M 10/0569; H01M 10/0525; H01M 10/0568; H01M 2300/0028

(57) ABSTRACT

An electrolyte solution includes a solvent; an electrolyte salt; and a LA:LB complex represented by the following general formula I: [(FnA)x-L] (I) In formula I, A is boron or phosphorous, F is fluorine, L is an aprotic organic amine, n is 3 or 5, when n=3, A is boron, and when n=5, A is phosphorous, x is an integer from 1-3, and at least one N atom of the aprotic organic amine, L, is bonded directly to A. The LA:LB complex is present in the solution in an amount of between 0.01 and 5.0 wt. %, based on the total weight of the electrolyte solution.

[(FₙA)ₓ-L] (I)

### FIELD

The present disclosure relates to electrolyte solutions for electrochemical cells.

### BACKGROUND

Various electrolyte compositions have been introduced for use in electrochemical cells. Such compositions are described, for example, in U.S. Pat. No. 8,765,294 B2; U.S. Pat. No. 8,241,787 B2; U.S. Pat. No. 6,045,948 A; and Brett L, Lucht, et. al., Journal of The Electrochemical Society, 152 (7), A1361-A1365 (2005).

### SUMMARY

In some embodiments, an electrolyte solution is provided. The electrolyte solution includes a solvent; an electrolyte salt; and a LA:LB complex represented by the following general formula I:

[(FₙA)ₓ-L] (I)

In formula I, A is boron or phosphorous, F is fluorine, L is an aprotic organic amine, n is 3 or 5, when n=3, A is boron, and when n=5, A is phosphorous, x is an integer from 1-3, and at least one N atom of the aprotic organic amine, L, is bonded directly to A. The LA:LB complex is present in the solution in an amount of between 0.01 and 5.0 wt. %, based on the total weight of the electrolyte solution.

In some embodiments, a method of making an electrolyte solution is provided. The method includes combining a solvent, an electrolyte salt, and a LA:LB complex. The LA:LB complex is represented by the following general formula (I):

[(FₙA)ₓ-L] (I)

In formula I, A is boron or phosphorous, F is fluorine, L is an aprotic organic amine, n is 3 or 5, when n=3, A is boron, and when n=5, A is phosphorous, x is an integer from 1-3, and at least one N atom of the aprotic organic amine, L, is bonded directly to A. The LA:LB complex is present in the solution in an amount of between 0.01 and 5.0 wt. %, based on the total weight of the electrolyte solution.

In some embodiments, an electrochemical cell is provided. The electrochemical cell includes a positive electrode, a negative electrode, and an electrolyte solution as described above.

In some embodiments, an electrolyte solution is provided. The electrolyte solution includes a solvent; an electrolyte salt; and a LA:LB complex represented by the following general formula I:

[(FₙA)ₓ-L] (I)

In formula I, A is boron or phosphorous, F is fluorine, L is an aprotic heteroaromatic amine, n is 3 or 5, when n=3, A is boron, and when n=5, A is phosphorous, x is an integer from 1-3, and at least one N atom of the aprotic heteroaromatic amine, L, is bonded directly to A. The LA:LB complex is present in the solution in an amount of between 0.01 and 5.0 wt. %, based on the total

The above summary is not intended to describe each disclosed embodiment of every implementation of the present disclosure. The brief description of the drawings and the detailed description which follows more particularly exemplify illustrative embodiments.

### BRIEF DESCRIPTION OF THE DRAWINGS

FIG. 1 shows a schematic cross sectional view of an exemplary lithium ion electrochemical cell.

FIG. 2 shows the capacity versus cycle number curves for Graphite/NMC111 cells cycled at 55° C. between 2.8-4.2V at 80 mA.

FIG. 3 shows the capacity versus cycle number curves for Graphite/NMC442 cells cycled at 55° C. between 2.8-4.4V at 80 mA.

### DETAILED DESCRIPTION

The most extensively used lithium-ion battery electrolytes have limited thermal and high voltage stability. Thermal and electrochemical degradation of the electrolyte is considered a primary cause of reduced lithium-ion battery performance over time. Many of the performance and safety issues associated with advanced lithium-ion batteries are the direct or indirect result of undesired reactions that occur between the electrolyte and the highly reactive positive or negative electrodes. Such reactions result in reduced cycle life, capacity fade, gas generation (which can result in cell swelling or venting), impedance growth, and reduced rate capability. Typically, driving the electrodes to greater voltage extremes or exposing the cell to higher temperatures accelerates these undesired reactions and magnifies the associated problems. Under extreme abuse conditions, uncontrolled reaction exotherms may result in thermal runaway and catastrophic disintegration of the cell.

Stabilizing the electrode/electrolyte interface is an important factor in controlling and minimizing these undesirable reactions and improving the cycle life and voltage and temperature performance limits of lithium-ion batteries. Electrolyte additives designed to selectively react with, bond to, or self-organize at the electrode surface in a way that passivates the interface represents one of the simplest and potentially most cost effective ways of achieving this goal. The effect of common electrolyte solvents and additives, such as ethylene carbonate (EC), vinylene carbonate (VC), 2-fluoroethylene carbonate (FEC), and lithium bisoxalatoborate (LiBOB), on the stability of the negative electrode SEI (solid-electrolyte interface) layer is well documented.

However, there is an ongoing need for electrolyte additives that are capable of further improving the high temperature performance and stability (e.g. >55° C.) of lithium ion cells, provide electrolyte stability at high voltages (e.g. >4.2V) for increased energy density, and enable the use of high voltage electrodes.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

As used herein, “stoichiometric LA:LB complex” means a complex in which its component elements are present in substantially the exact proportions indicated by the formula of the complex.

As used herein, “aprotic organic amine” means an organic compound that includes nitrogen, and in which there are no hydrogen atoms directly bound to nitrogen or directly bound to other heteroatoms (such as O and S) that may optionally be present in the compound.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, the present disclosure, in some embodiments, relates to a class of Lewis acid:Lewis base (LA:LB) complexes that can act as performance enhancing additives to the electrolytes of electrochemical cells (e.g., lithium ion electrochemical cells). These complexes can provide performance benefits in electrochemical cells when used at relatively low loadings in the electrolyte (e.g., <5 wt % of the total electrolyte solution). For example, electrochemical cells having electrolytes that include the LA:LB complexes of the present disclosure, relative to known electrolytes including known additives, may exhibit improved high temperature storage performance, improved coulombic efficiency, improved charge endpoint capacity slippage, less impedance growth, reduced gas generation and improved charge-discharge cycling. Furthermore, the LA:LB complexes of the present disclosure may display relatively high stability in ambient air, thus providing improved ease of handling and improved safety vs. known LA:LB complexes (e.g., BF₃-diethyl ether and BF₃-dimethyl carbonate, which rapidly hydrolyze in air to produce a visible white smoke (due to HF formation)). Still further, the unexpected efficacy of the present LA:LB complexes at low loadings can lead to a reduction in overall electrolyte additive cost per electrochemical cell. Indeed, reduction in material costs is an important factor in the adoption of lithium-ion battery technology in new applications (e.g., electric vehicles, renewable energy storage).

In some embodiments, the present disclosure relates to electrolyte solutions for electrochemical cells. The electrolyte solutions may include a solvent, one or more salts, and one or more LA:LB complexes.

In various embodiments, the electrolyte solutions may include one or more solvents. In some embodiments, the solvent may include one or more organic carbonates. Examples of suitable solvents include ethylene carbonate, diethyl carbonate, dimethyl carbonate, ethyl methyl carbonate, vinylene carbonate, propylene carbonate, fluoroethylene carbonate, tetrahydrofuran (THF), acetonitrile, gamma butyrolactone, sulfolane, ethyl acetate, or combinations thereof. In some embodiments, organic polymer containing electrolyte solvents, which can include solid polymer electrolytes or gel polymer electrolytes, may also be employed. Organic polymers may include polyethylene oxide, polypropylene oxide, ethylene oxide/propylene oxide copolymers, polyacrylonitrile, polyvinylidene fluoride, vinylidene fluoride-hexafluoropropylene copolymers, and poly-[bis((methoxyethoxy)ethoxy)phosphazene] (MEEP), or combinations thereof. The solvents may be present in the electrolyte solution in an amount of between 15 and 98 wt. %, 25 and 95 wt. %, 50 and 90 wt. %, or 70 and 90 wt. %, based on the total weight of the electrolyte solution.

In some embodiments, the electrolyte solution may include one or more electrolyte salts. In some embodiments, the electrolyte salts may include lithium salts and, optionally, other salts such as sodium salts (e.g., NaPF₆). Suitable lithium salts may include LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), LiN(SO₂F)(SO₂C₄F₉), or combinations thereof. In some embodiments, the lithium salts may include LiPF₆, lithium bis(oxalato)borate, LiN(SO₂CF₃)₂, or combinations thereof. In some embodiments, the lithium salts may include LiPF₆ and either or both of lithium bis(oxalato)borate and LiN(SO₂CF₃)₂. The salts may be present in the electrolyte solution in an amount of between 2 and 85 wt %, 5 and 75 wt %, 10 and 50 wt %, or 10 and 30 wt %, based on the total weight of the electrolyte solution.

In some embodiments, the electrolyte solutions may include one or more LA:LB complexes. The LA:LB complexes may have the following formula (I):

[(FₙA)ₓ-L] (I)

where A is boron or phosphorous,

F is fluorine,

L is an aprotic organic amine,

n is 3 or 5,

when n=3, A is boron, and when n=5, A is phosphorous, and

x is an integer from 1-3 or 1-2.

In some embodiments, the LA:LB complex may be a stoichiometric LA:LB complex (i.e., very little, if any, excess (or uncomplexed) Lewis acid or Lewis base may be present in the electrolyte). For example, excess Lewis acid or Lewis base may be present in the electrolyte solution at less than 10 mol %, less than 5 mol %, less than 3 mol %, or less than 1 mol %, based on the stoichiometry indicated in the LA:LB complex structural formula(s).

In some embodiments, the Lewis acid and Lewis base components of the LA:LB complex may be bonded together via a dipolar, co-ordinate (or dative) covalent bond formed by donation of a lone (or non-bonding) electron pair on at least one N atom of the Lewis base to the empty (or unoccupied) orbital on the B or P atom of the Lewis acid (BF₃ or PF₅, respectively). Thus, the LA:LB complex may be held together by at least one B—N or P—N bond and at least one N atom of the aprotic organic amine, L, is bonded directly to A in formula (I)

In some embodiments, the aprotic organic amine (L) in formula (I) may include at least one N atom with a non-bonding electron pair that is available for bonding with an empty orbital of the Lewis acid (FₙA). In illustrative embodiments, the aprotic organic amines may include tertiary amines that may be cyclic or acyclic, saturated or unsaturated, substituted or unsubstituted, and may optionally contain other catenary heteroatoms, such as O, S, and N, in the carbon chain or ring. In some embodiments, the aprotic organic amines may include heteroaromatic amines that may be substituted or unsubstituted and may optionally contain other catenary heteroatoms, such as O, S, and N, in the carbon chain or ring.

In some embodiments, suitable tertiary amines may include trimethylamine, triethylamine, tributylamine, tripentylamine, trihexylamine, trioctylamine, N,N-diisopropylethylamine, benzyldimethylamine, triphenylamine, N,N-diethylmethylamine, N-methylpiperidine, N-ethylpiperidine, 1-chloro-N,N-dimethyl-methanamine, N-ethyl-N-(methoxymethyl)-ethanamine, N-methylpyrrolidine, N-ethylpyrrolidine, N-propylpyrrolidine, N-butyllpyrrolidine, 1,8-diazabicycloundec-7-ene, 1,5-diazabicyclo[4.3.0]non-5-ene, 7-methyl-1,5,7-triazabicyclo[4.4.0]dec-5-ene, 1,4-diazabicyclo-[2.2.2]-octane, 1-azabicyclo[2.2.2]-octane, N,N,N′,N′-tetramethyl-1,4-butanediamine, N,N,N′,N′-tetramethyl-2-butene-1,4-diamine, N,N,N′,N′,N″-pentamethyldiethylenetriamine, 1,3,5-trimethylhexahydro-1,3,5-triazine, 2-isopropyliminopropane, 4-methylmorpholine, 1-[(methylthio)methyl]-piperidine.

In some embodiments, suitable heteroaromatic amines may include pyridine, pyrazine, pyridazine, pyrimidine, 4-dimethylaminopyridine, 1-methylimidizole, 1-methylpyrazole, thiazole, oxazole, all isomers thereof and substituted variants thereof wherein the substituent groups can include either H; F; nitrile groups; separate alkyl or fluoroalkyl groups from 1 to 4 carbon atoms, respectively or joined together to constitute a unitary alkylene radical of 2 to 4 carbon atoms forming a ring structure; alkoxy or fluoroalkoxy groups; or separate aryl of fluoroaryl groups.

In some embodiments, the LA:LB complexes may be selected from:

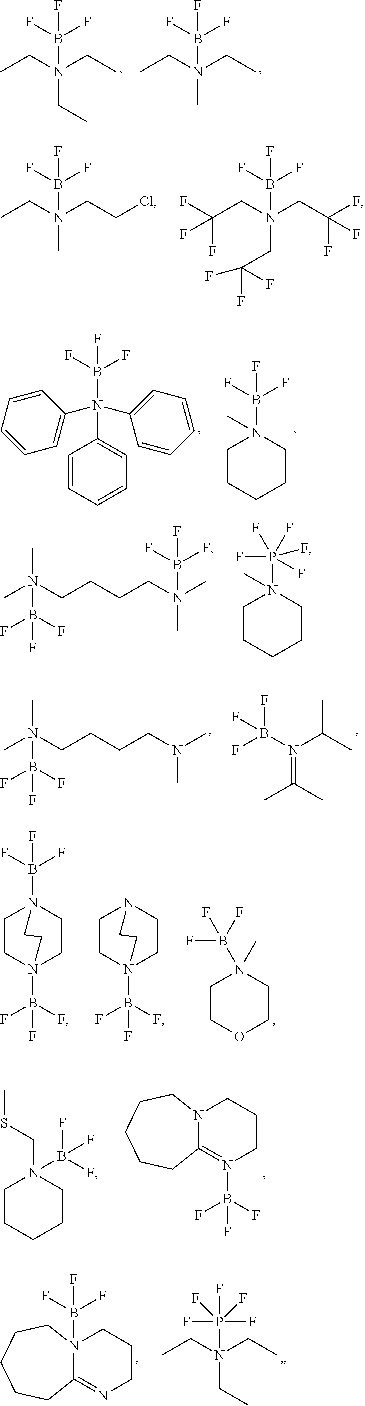

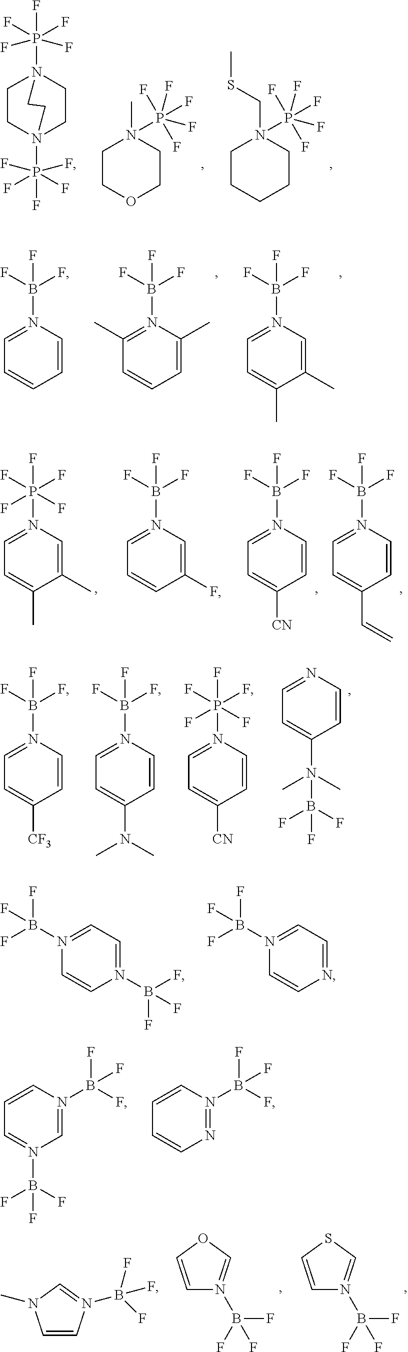

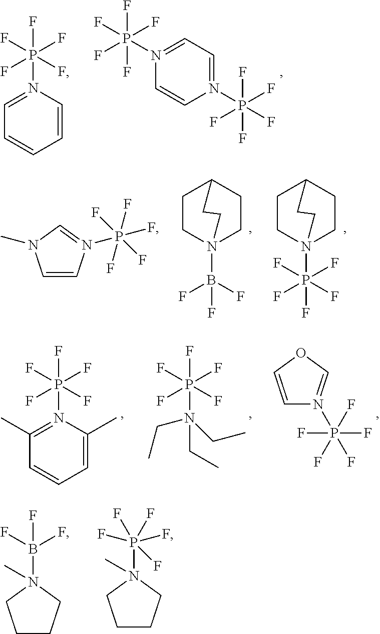

or combinations thereof

In some embodiments, the LA:LB complex or complexes may be present in the electrolyte solution in an amount of between 0.01 and 40.0 wt. %, 0.01 and 20.0 wt. %, 0.01 and 10.0 wt. %, 0.01 and 5.0 wt. %, 0.1 and 5.0 wt. %, or 0.5 and 5.0 wt. % based on the total weight of the electrolyte solution.

In addition to the components described above, in some embodiments, the electrolyte solutions of the present disclosure may include one or more conventional electrolyte additives such as, for example, vinylene carbonate (VC), fluoroethylene carbonate (FEC), propane-1,3-sultone (PS), prop-1-ene-1,3-sultone (PES), succinonitrile (SN), 1,5,2,4-dioxadithiane-2,2,4,4-tetraoxide (MMDS), lithium bis(oxalate)borate (LiBOB), lithium difluoro(oxalato)borate (LiDFOB), tris(trimethylsilyl)phosphite (TTSPi), ethylene sulfite (ES), 1,3,2-dioxathiolan-2,2-oxide (DTD), vinyl ethylene carbonate (VEC), trimethylene sulfite (TMS), tri-allyl-phosphate (TAP), methyl phenyl carbonate (MPC), diphenyl carbonate (DPC), ethyl phenyl carbonate (EPC), and tris(trimethylsilyl)phosphate (TTSP).

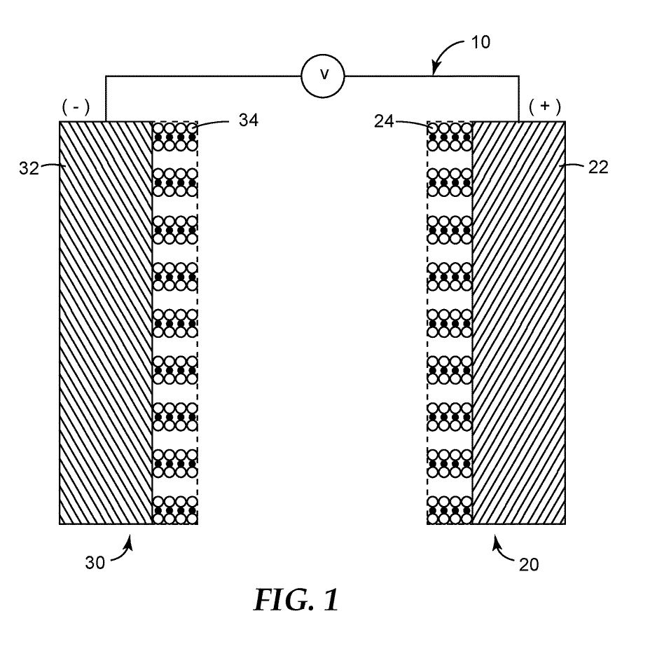

In some embodiments, the present disclosure is further directed to electrochemical cells (e.g., lithium-ion electrochemical cells as shown in FIG. 1) that include the above-described electrolyte solutions. In addition to the electrolyte solution, the electrochemical cells may include at least one positive electrode, at least one negative electrode, and a separator.

In some embodiments, the positive electrode may include a current collector having disposed thereon a positive electrode composition. The current collector for the positive electrode may be formed of a conductive material such as a metal. According to some embodiments, the current collector includes aluminum or an aluminum alloy. According to some embodiments, the thickness of the current collector is 5 μm to 75 μm. It should also be noted that while the positive current collector may be described as being a thin foil material, the positive current collector may have any of a variety of other configurations according to various exemplary embodiments. For example, the positive current collector may be a grid such as a mesh grid, an expanded metal grid, a photochemically etched grid, or the like.

In some embodiments, the positive electrode composition may include an active material. The active material may include a lithium metal oxide or lithium metal phosphate. In an exemplary embodiment, the active material may include lithium transition metal oxide intercalation compounds such as LiCoO₂, LiCo_{0.2}Ni_{0.8}O₂, LiMn₂O₄, LiFePO₄, LiNiO₂, or lithium mixed metal oxides of manganese, nickel, and cobalt in any proportion. Blends of these materials can also be used in positive electrode compositions. Other exemplary cathode materials are disclosed in U.S. Pat. No. 6,680,145 (Obrovac et al.) and include transition metal grains in combination with lithium-containing grains. Suitable transition metal grains include, for example, iron, cobalt, chromium, nickel, vanadium, manganese, copper, zinc, zirconium, molybdenum, niobium, or combinations thereof with a grain size no greater than about 50 nanometers. Suitable lithium-containing grains can be selected from lithium oxides, lithium sulfides, lithium halides (e.g., chlorides, bromides, iodides, or fluorides), or combinations thereof. The positive electrode composition may further include additives such as binders (e.g., polymeric binders (e.g., polyvinylidene fluoride)), conductive diluents (e.g., carbon), fillers, adhesion promoters, thickening agents for coating viscosity modification such as carboxymethylcellulose, or other additives known by those skilled in the art.

The positive electrode composition can be provided on only one side of the positive current collector or it may be provided or coated on both sides of the current collector. The thickness of the positive electrode composition may be 0.1 μm to 3 mm, 10 μm to 300 μm, or 20 μm to 90 μm.

In various embodiments, the negative electrode may include a current collector and a negative electrode composition disposed on the current collector. The current collector of the negative electrode may be formed of a conductive material such as a metal. According to some embodiments, the current collector includes copper or a copper alloy, titanium or a titanium alloy, nickel or a nickel alloy, or aluminum or an aluminum alloy. According to some embodiments, the thickness of the current collector may be 5 μm to 75 μm. It should also be noted that while the current collector of the negative electrode may be described as being a thin foil material, the current collector may have any of a variety of other configurations according to various exemplary embodiments. For example, the current collector of the negative electrode may be a grid such as a mesh grid, an expanded metal grid, a photochemically etched grid, or the like.

In some embodiments, the negative electrode composition may include an active material (e.g., a material that is capable of intercalating or alloying with lithium.) The active material may include lithium metal, carbonaceous materials, or metal alloys (e.g., silicon alloy composition or lithium alloy compositions). Suitable carbonaceous materials can include synthetic graphites such as mesocarbon microbeads (MCMB) (available from China Steel, Taiwan, China), SLP30 (available from TimCal Ltd., Bodio Switzerland), natural graphites and hard carbons. Suitable alloys may include electrochemically active components such as silicon, tin, aluminum, gallium, indium, lead, bismuth, and zinc and may also include electrochemically inactive components such as iron, cobalt, transition metal silicides and transition metal aluminides. In some embodiments, the active material of the negative electrode includes a silicon alloy.

In some embodiments, the negative electrode composition may further include additives such as binders (e.g., polymeric binders (e.g., polyvinylidene fluoride or styrene butadiene rubber (SBR)), conductive diluents (e.g., carbon black and/or carbon nanotubes), fillers, adhesion promoters, thickening agents for coating viscosity modification such as carboxymethylcellulose, or other additives known by those skilled in the art.

In various embodiments, the negative electrode composition can be provided on only one side of the negative current collector or it may be provided or coated on both sides of the current collector. The thickness of the negative electrode composition may be 0.1 μm to 3 mm, 10 μm to 300 μm, or 20 μm to 90 μm.

In some embodiments, the electrochemical cells of the present disclosure may include a separator (e.g., a polymeric microporous separator which may or may not be coated with a layer of inorganic particles such as Al₂O₃) provided intermediate or between the positive electrode and the negative electrode. The electrodes may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as another lithium ion battery configuration.

According to some embodiments, the separator can be a polymeric material such as a polypropylene/polyethylene copolymer or another polyolefin multilayer laminate that includes micropores formed therein to allow electrolyte and lithium ions to flow from one side of the separator to the other. The thickness of the separator may be between approximately 10 micrometers (μm) and 50 μm according to an exemplary embodiment. The average pore size of the separator may be between approximately 0.02 μm and 0.1 μm.

In some embodiments, the present disclosure is further directed to electronic devices that include the above-described electrochemical cells. For example, the disclosed electrochemical cells can be used in a variety of devices including, without limitation, portable computers, tablet displays, personal digital assistants, mobile telephones, motorized devices (e.g., personal or household appliances and vehicles), power tools, illumination devices, and heating devices.

The present disclosure further relates to methods of making an electrochemical cell. In various embodiments, the method may include providing the above-described negative electrode, providing the above-described positive electrode, and incorporating the negative electrode and the positive electrode into a battery comprising the above-described electrolyte solution.

### Examples

Objects and advantages of this disclosure are further illustrated by the following illustrative examples.

### Examples

Objects and advantages of this disclosure are further illustrated by the following illustrative examples.

### LIST OF MATERIALS

| Name | Description | Source |
|---|---|---|
| Ethylene Carbonate (EC) | 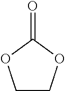 | BASF, USA |
| Ethyl Methyl Carbonate (EMC) | 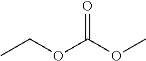 | BASF, USA |
| Dimethyl Carbonate (DMC) | 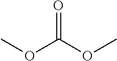 | BASF, USA |
| Lithium hexafluoro phosphate | LiPF₆ | BASF, USA |
| NMC111 | LiNi_{0.33}Mn_{0.33}Co_{0.33}O₂ | Umicore, Korea |
| NMC442 | LiNi_{0.42}Mn_{0.42}Co_{0.16}O₂ | Umicore, Korea |
| Lithium Cobalt Oxide (LCO) | LiCoO₂ | Umicore, Korea |
| Conductive Carbon | Super P | Timcal graphite |
| | | and carbon, |
| | | Switzerland |
| PVDF | Polyvinylidene Fluoride | Arkema, USA |
| MCMB | Meso Carbon Micro Bead | China Steel, |
| | | Taiwan |
| N-Methyl-2-Pyrrolidone (NMP) | 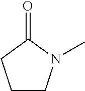 | Honeywell, USA |
| Triallylphosphate (TAP) | O═P(OCH₂CH═CH₂)₃ | Capchem, |
| | | China |
| Boron Trifluoride:diethyletherate | 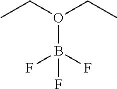 | Aldrich, USA |
| Phosphorous Pentafluoride | PF₅ | Synquest |
| Vinylene Carbonate (VC) | 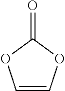 | BASF, USA |
| prop-1-ene, 1,3-sultone (PES) | 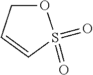 | Aldrich, USA |
| Tributylamine | 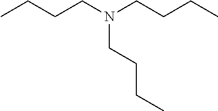 | Aldrich, USA |
| 1,8-diazabicycloundec-7-ene (DBU) | 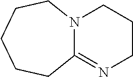 [SMILES: C1CCC2=NCCCN2CC1] | Aldrich, USA |
| 1,4-diazabicyclo-[2.2.2]-octane (DABCO) | 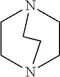 | Aldrich, USA |
| Pyridine | 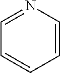 | Aldrich, USA |
| 3-fluoropyridine | 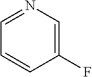 | Aldrich, USA |
| 2-fluoropyridine | 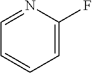 | Aldrich, USA |
| 3,4-Lutidine | 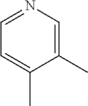 | Aldrich, USA |
| 2,6-Lutidine | 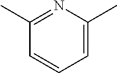 | Aldrich, USA |
| 3-pyridine carbonitrile | 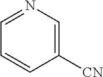 | Aldrich, USA |
| 4-vinyl pyridine | 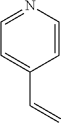 | Aldrich, USA |
| 4-trifluoromethylpyridine | 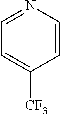 | Aldrich, USA |
| Pyrazine | 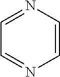 | Aldrich, USA |
| 4-dimethylaminopyridine | 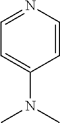 | Aldrich, USA |
| 1-methylimidazole | 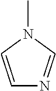 | Aldrich, USA |

### Preparation of 1:1 Boron Trifluoride Pyridine Complex

To an oven dried Schlenk tube (reaction flask equipped with N₂ sidearm), anhydrous pyridine (2.94 g, 0.0372 mol) was charged. The reaction flask was capped and placed under an inert atmosphere (N₂, He or Ar) and cooled in an ice bath near 0° C. Boron trifluoride diethyl etherate (4.602 g, 0.0324 mol) was added to the pyridine via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the reaction was vacuum stripped of diethyl ether and excess pyridine using a high vacuum line while the product was heated to 45° C. before transferring to a nitrogen glove box for storage. The appearance of the solid product ranged from colorless to pale yellow amorphous to crystalline solids. The mass yield of the isolated product was used to confirm the synthesis of the desired material. Furthermore, the identity of the product was confirmed by ¹H and ¹⁹F NMR spectroscopy.

### Preparation of 1:1 Boron Trifluoride 2,6-Lutidine Complex

To an oven dried Schlenk tube (reaction flask equipped with N₂ sidearm), anhydrous 2,6-lutidine (3.54 g, 0.0330 mol) and diethyl ether (14.16 g, 0.1667 mol) were charged. The reaction flask was capped and placed under an inert atmosphere (N₂, He or Ar) and cooled in an ice bath to 0° C. Boron trifluoride diethyl etherate (4.602 g, 0.0324 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant of the reaction mixture was removed via syringe. The solid product was washed twice under inert atmosphere with 10 mL aliquots of anhydrous diethyl ether before it was vacuum stripped of diethyl ether and excess amine using a high vacuum line while the product was heated to 45° C. before transferring to a nitrogen glove box for storage. The appearance of the product ranged from colorless to pale yellow amorphous to crystalline solid. The mass yield of the isolated product was used to confirm the synthesis of the desired material. Furthermore, the identity of the product was confirmed by ¹H and ¹⁹F NMR spectroscopy.

### Preparation of (2:1) Boron Trifluoride Pyrazine Complex

To an oven dried Schlenk tube (reaction flask equipped with N₂ sidearm), pyrazine (3.54 g, 0.0330 mol) and diethyl ether (10.08 g, 0.1360 mol) were charged. The reaction flask was capped and placed under an inert atmosphere (N₂, He or Ar) and cooled in an ice bath to 0° C. Boron trifluoride diethyl etherate (9.20 g, 0.0648 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant of the reaction mixture was removed via syringe. The solid product was washed twice under inert atmosphere with 10 mL aliquots of anhydrous diethyl ether before it was vacuum stripped of diethyl ether using a high vacuum line while the product was heated to 45° C. before transferring to a nitrogen glove box for storage. The appearance of the product ranged from colorless to pale yellow amorphous to crystalline solids. The mass yield of the isolated product was used to confirm synthesis of the desired 2:1 BF₃:pyrazine complex.

### Preparation of 1:1 Boron Trifluoride 1-Methylimidizole Complex

To an oven dried Schlenk tube (reaction flask equipped with N₂ sidearm), anhydrous 1-methylimidizole (2.71 g, 0.0331 mol) and diethyl ether (7.13 g, 0.0962 mol) were charged. The reaction flask was capped and placed under an inert atmosphere (N₂, He or Ar) and cooled in an ice bath to 0° C. Boron trifluoride diethyl etherate (4.60 g, 0.0324 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant of the reaction mixture was removed via syringe. The solid product was washed twice under inert atmosphere with 10 mL aliquots of anhydrous diethyl ether before it was vacuum stripped of diethyl ether using a high vacuum line while the product was heated to 45° C. The final solid product was transferred to a nitrogen glove box for storage. The appearance of the product ranged from colorless to pale yellow amorphous to crystalline solids. The mass yield of the isolated product was used to confirm the synthesis of the desired material.

### Preparation of 1:1 Boron Trifluoride 1,8-Diazabicycloundec-7-ene Complex

To an oven dried Schlenk tube (reaction flask equipped with N₂ sidearm), anhydrous 1,8-Diazabicycloundec-7-ene (5.03 g, 0.0330 mol) and diethyl ether (7.13 g, 0.0946 mol) were charged. The reaction flask was capped and placed under an inert atmosphere (N₂, He or Ar) and cooled in an ice bath to 0° C. Boron trifluoride diethyl etherate (4.602 g, 0.0324 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant liquid was removed via syringe. The solid product was washed twice under inert atmosphere with 10 mL aliquots of anhydrous diethyl ether before it was vacuum stripped of diethyl ether using a high vacuum line while the product was heated to 45° C. The final solid product was then transferred to a nitrogen glove box for storage. The appearance of the product ranged from colorless to pale yellow amorphous to crystalline solids. The mass yield of the isolated product was used to confirm the synthesis of the desired material.

### Preparation of 1:1 Boron Trifluoride 4-Dimethylaminopyridine Complex

To an oven dried Schlenk tube (reaction flask equipped with N₂ sidearm), anhydrous 4-dimethylaminopyridine (4.04, 0.0331 mol) and diethyl ether (7.13 g, 0.0946 mol) were charged. The reaction flask was capped and placed under an inert atmosphere (N₂, He or Ar) and cooled in an ice bath to 0° C. Boron trifluoride diethyl etherate (4.602 g, 0.0324 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant liquid was removed via syringe. The solid product was washed twice under inert atmosphere with 10 mL aliquots of anhydrous diethyl ether before it was vacuum stripped of diethyl ether under high vacuum while the product was heated to 45° C. The final solid product was then transferred to a nitrogen glove box for storage. The appearance of the product ranged from colorless to pale yellow amorphous to crystalline solids. The mass yield of the isolated product was used to confirm the synthesis of the desired material.

### Preparation of 2:1 Boron Trifluoride 1,4-Diazabicyclo[2.2.2]octane Complex

To an oven dried Schlenk tube (reaction flask equipped with N₂ sidearm), 1,4-diazabicyclo[2.2.2]octane (DABCO) (1.91, 0.0170 mol) and diethyl ether (9.27 g, 0.1081 mol) were charged. The reaction flask was capped and placed under an inert atmosphere (N₂, He or Ar) and cooled in an ice bath to 0° C. Boron trifluoride diethyl etherate (4.60 g, 0.0324 mol) was added to the amine solution via syringe under inert atmosphere. Solids precipitated as the boron trifluoride diethyl etherate was added to the reaction mixture. After all of the boron trifluoride diethyl etherate was charged, the reaction mixture was cooled to −20° C. in a freezer overnight to promote crystal growth. The following morning the supernatant liquid was removed via syringe. The solid product was washed twice under an inert atmosphere with 10 mL aliquots of anhydrous diethyl ether before it was vacuum stripped of diethyl ether under high vacuum while the product was heated to 45° C. The final solid product was then transferred to a nitrogen glove box for storage. The appearance of the product ranged from colorless to pale yellow amorphous to crystalline solids. The mass yield of the isolated product indicated the desired 2:1 BF₃:DABCO complex was formed.

### Preparation of 1:1 Boron Trifluoride Tributylamine Complex

To an oven dried Schlenk tube (reaction flask equipped with N₂ sidearm), anhydrous tributylamine (6.127, 0.0331 mol) was charged. The reaction flask was capped and placed under an inert atmosphere (N₂, He or Ar) and cooled in an ice bath near 0° C. Boron trifluoride diethyl etherate (4.602 g, 0.0324 mol) was added to the tributylamine via syringe under inert atmosphere. No solids precipitated. After all of the boron trifluoride diethyl etherate was charged, the reaction mixture was cooled to −20° C. in a freezer overnight to promote crystal growth, but no solids formed. The following morning the reaction was vacuum stripped of diethyl ether. While the solvent was being removed a waxy solid began to form. Product was heated to 45° C. to ensure all diethyl ether was removed before transferring to a nitrogen glove box for storage. The appearance of the solid product ranged from colorless to pale yellow amorphous to crystalline solids. The mass yield of the isolated product was used to confirm the synthesis of the desired material. Furthermore, the identity of the product was confirmed by ¹H and ¹⁹F NMR spectroscopy.

### Preparation of 1:1 Boron Trifluoride 4-Cyanopyridine Complex

In an inert atmosphere glovebox (Ar), 4-cyanopyridine (1.00 g, 0.0096 mol) was dissolved in chloroform (2.98 g, 0.0250 mol) in a dry NALGENE bottle. Boron trifluoride diethyl etherate (1.41 g, 0.0099 mol) was slowly charged to the reaction mixture causing a solid precipitate to form. After all of the boron trifluoride diethyl etherate was charged, the reaction mixture was cooled to −20° C. in a freezer overnight to promote crystal growth. The following morning, the solvent was decanted and the product was washed twice with chloroform before it was vacuum stripped under high vacuum at 45° C. to remove residual solvent. The appearance of the product ranged from colorless to pale yellow amorphous to crystalline solids. The identity of the product was confirmed by ¹H, ¹¹B and ¹⁹F NMR spectroscopy.

### Preparation of 1:1 Boron Trifluoride 4-(Trifluoromethyl) Pyridine Complex

In an inert atmosphere glovebox (Ar), 4-(trifluoromethyl)pyridine (2.00 g, 0.0136 mol) was charged to a dry NALGENE bottle. Boron trifluoride diethyl etherate (2.30 g, 0.0162 mol) was then slowly added causing a solid precipitate to form. After all of the boron trifluoride diethyl etherate was charged, the reaction mixture was cooled to −20° C. in a freezer overnight to promote crystal growth. The following morning the product was vacuum stripped under high vacuum at 45° C. to remove residual volatiles. The appearance of the product ranged from colorless to pale yellow amorphous to crystalline solids. The identity of the product was confirmed by ¹H NMR spectroscopy.

### Preparation of 1:1 Boron Trifluoride 2-Fluoropyridine Complex

In an inert atmosphere glovebox (Ar), 2-fluoropyridine (1.20 g, 0.0124 mol) was charged to a dry NALGENE bottle. Boron trifluoride diethyl etherate (2.30 g, 0.0162 mol) was then slowly added causing a solid precipitate to form. After all of the boron trifluoride diethyl etherate was charged the reaction mixture was cooled to −20° C. in a freezer overnight to promote crystal growth. The following morning the product was vacuum stripped under high vacuum at 45° C. to remove residual volatiles. The appearance of the product ranged from colorless to pale yellow amorphous to crystalline solids.

### Preparation of 1:1 Boron Trifluoride 3,4-Lutidine Complex

In an inert atmosphere glovebox (Ar), 3,4-lutidine (1.50 g, 0.0140 mol) was charged to a dry NALGENE bottle. Boron trifluoride diethyl etherate (2.30 g, 0.0162 mol) was then slowly added causing a solid precipitate to form. After all of the boron trifluoride diethyl etherate was charged, the reaction mixture was cooled to −20° C. in a freezer overnight to promote crystal growth. The following morning, the product was vacuum stripped under high vacuum at 45° C. to remove residual volatiles. The appearance of the product ranged from colorless to pale yellow amorphous to crystalline solids. The identity of the product was confirmed by ¹H and ¹⁹F NMR spectroscopy.

### Preparation of 1:1 Boron Trifluoride 4-Vinylpyridine Complex

In an inert atmosphere glovebox (Ar), 4-vinylpyridine (1.50 g, 0.0142 mol) was charged to a dry NALGENE bottle. Boron trifluoride diethyl etherate (2.30 g, 0.0162 mol) was then slowly added causing a solid precipitate to form. After all of the boron trifluoride diethyl etherate was charged, the reaction mixture was cooled to −20° C. in a freezer overnight to promote crystal growth. The following morning, the product was vacuum stripped under high vacuum at 45° C. to remove residual volatiles. The appearance of the product ranged from colorless to pale yellow amorphous to crystalline solids. The identity of the product was confirmed by ¹H and ¹¹B NMR spectroscopy.

### Preparation of 1:1 Boron Trifluoride 3-Fluoropyridine Complex

In an inert atmosphere glovebox (Ar), 3-fluoropyridine (1.50 g, 0.0154 mol) was charged to a dry NALGENE bottle. Boron trifluoride diethyl etherate (2.30 g, 0.0202 mol) was then slowly added causing a solid precipitate to form. After all of the boron trifluoride diethyl etherate was charged, the reaction mixture was cooled to −20° C. in a freezer overnight to promote crystal growth. The following morning, the product was vacuum stripped under high vacuum at 45° C. to remove residual volatiles. The appearance of the product ranged from colorless to pale yellow amorphous to crystalline solids. The identity of the product was confirmed by ¹H NMR spectroscopy.

### Preparation of 1:1 Phosphorus Pentafluoride Pyridine Complex

Pyridine (12.56 g, 0.1588 mmol) was charged to the oven dried body of a Parr reactor. Following addition of the pyridine, the reactor was fully assembled, sealed, and then cooled in a dry ice bath. Once cool, vacuum was pulled on the contents of the reactor using a water aspirator vacuum pump. The contents of the reactor were stirred as they were allowed to warm to room temperature. Then, phosphorus pentafluoride gas (10.00 g, 0.7939 mmol) was charged to the evacuated reactor at room temperature via reinforced pressure tubing. The temperature within the reactor spiked to 53° C. during addition of PF₅, indicating that an exothermic reaction had occurred. The reaction mixture was stirred overnight at room temperature. The following morning, the entire Parr reactor was transferred to a nitrogen glove box where it was opened revealing solid product. The crude product was washed three times with 10 mL portions of heptane before being transferred to a sublimation apparatus where it was purified by vacuum sublimation at 120° C., 10⁻² Torr. The appearance of the solid product ranged from colorless to pale yellow amorphous to crystalline solids. The identity of the product was confirmed by ¹H and ¹⁹F NMR spectroscopy.

### Preparation of Electrolyte

1 M LiPF₆ EC/EMC (3:7 wt. % ratio, BASF) was used as the base electrolyte in the studies reported here. To this electrolyte, various Lewis acid:Lewis base complex electrolyte additives, listed in Table 1, were added either singly or in combination with other additives. Additive components were added at specified weight percentages in the electrolyte. Other electrolyte additives were also used in comparative examples where indicated. These include, but are not limited to, vinylene carbonate (VC), prop-1-ene-1,3-sultone (PES), triallyl phosphate (TAP), ethylene sulfate [1,3,2-dioxathiolane-2,2-dioxane (DTD)] BF3:diethyl ether (BFE) and BF3:dimethyl carbonate (BFC).

The solubility of each additive was measured in the base electrolyte solution and is reported in Table 1. All of the additives have sufficient solubility (>0.1 wt %) to be useful as electrolyte additives.

TABLE 1
The solubility of Lewis acid:Lewis base electrolyte additives

| | Solubility in 1M |
|---|---|
| | LiPF₆ EC:EMC |
| Lewis acid:Lewis base complex | 3:7 by wt. |
| Boron Trifluoride Pyridine (1:1) | >2% |
| Boron Trifluoride 2,6-Lutidine (1:1) | >2% |
| Boron Trifluoride Pyrazine (2:1) | Approx. 0.5% |
| Boron Trifluoride 1-Methylimidizole (1:1) | >2% |
| Boron Trifluoride 1,8-Diazabicycloundec-7- | >2% |
| ene (1:1) | |
| Boron Trifluoride 4-Dimethylaminopyridine | >2% |
| (1:1) | |
| Boron Trifluoride 1,4- | Approx. 0.5% |
| Diazabicyclo[2.2.2]octane (2:1) | |
| Boron Trifluoride Tributylamine (1:1) | >2% |
| Boron Trifluoride 4-Cyanopyridine (1:1) | >2% |
| Boron Trifluoride 4-(trifluoromethyl) | >2% |
| pyridine (1:1) | |
| Boron Trifluoride 2-Fluoropyridine (1:1) | Approx. 2% |
| Boron Trifluoride 3,4-Lutidine (1:1) | >2% |
| Boron Trifluoride 4-Vinylpyridine (1:1) | Approx. 2% |
| Boron Trifluoride 3-Fluoropyridine (1:1) | >2% |
| Phosphorus Pentafluoride Pyridine (1:1) | >2% |

### Electrochemical Cell Preparation

Dry Li[Ni_{0.33}Mn_{0.33}Co_{0.33}]O₂ (NMC111)/graphite pouch cells (240 mAh), dry Li[Ni_{0.42}Mn_{0.42}Co_{0.16}]O₂ (NMC442)/graphite pouch cells (240 mAh), and Li[Ni_{0.5}Mn_{0.3}Co_{0.2}]O₂ (NMC532)/graphite pouch cells (220 mAh) were obtained without electrolyte from Li-Fun Technology Corporation (Xinma Industry Zone, Golden Dragon Road, Tianyuan District, Zhuzhou City, Hunan Province, PRC, 412000, China). The electrode composition in the cells was as follows: Positive electrode−96.2%:1.8%:2.0%=Active Material:Carbon Black:PVDF Binder; Negative electrode−95.4%:1.3%:1.1%:2.2%=Active material:Carbon Black:CMC:SBR. The positive electrode coating had a thickness of 105 μm and was calendared to a density of 3.55 g/cm³. The negative electrode coating had a thickness of 110 μm and was calendared to a density of 1.55 g/cm³. The positive electrode coating had an areal density of 16 mg/cm² and the negative electrode had an areal density of 9.5 mg/cm². The positive electrode dimensions were 200 mm×26 mm and the negative electrode dimensions were 204 mm×28 mm. Both electrodes were coated on both sides, except for small regions on one side at the end of the foils. All pouch cells were vacuum sealed without electrolyte in China. Before electrolyte filling, the cells were cut just below the heat seal and dried at 80° C. under vacuum for 14 h to remove any residual water. Then the cells were transferred immediately to an argon-filled glove box for filling and vacuum sealing. The NMC/graphite pouch cells for 4.4V/40° C. storage, 4.5V/40° C. storage, and long term cycle experiments were filled with 0.9 g of electrolyte while the same pouch cells for 4.4V/60° C. storage experiments were filled with 0.75 g of electrolyte. After filling, cells were vacuum-sealed with a compact vacuum sealer (MSK-115A, MTI Corp.). First, cells were placed in a temperature box at 40.0+0.1° C. where they were held at 1.5 V for 24 hours, to allow for the completion of wetting. Then, cells were charged at 11 mA (C/20) to 3.8 V. After this step, cells were transferred and moved into the glove box, cut open to release gas generated and then vacuum sealed again. After degassing, impedance spectra of the cells were measured at 3.8 V as described below. The NMC/graphite cells destined for 4.5V operation were degassed a second time at 4.5 V. The amounts of gas created during formation to 3.8 V and between 3.8 V and 4.5 V were measured and recorded for NMC111 and NMC442. The amount of gas created during formation to 3.5 V and between 3.5 V and 4.5 V was measured and recorded for NMC532 cells.

### Ultrahigh Precision Cycling Test Protocol

The cells were cycled using the Ultra High Precision Charger (UHPC) at Dalhousie University (Halifax, Calif.) between 3.0 and either 4.2 V or 4.4 V at 40.±0.1° C. using currents corresponding to C/20 for 15 cycles where comparisons were made. Some cells were stored before UHPC cycling to mature their negative electrode SEI before testing. Coulombic efficiency, charge endpoint capacity slippage, gas volume, charge transfer impedance rise were measured during UHPC cycling. The coulombic efficiency is the ratio of the discharge to charge capacity of a given cycle. The charge endpoint capacity slippage is defined as the extent to which the top of charge endpoint slips to higher capacity with each charging cycle. It is typically measured by subtracting the charge capacity of a given cycle from the charge capacity of the previous cycle.

### Electrochemical Storage Test Protocol

The cycling/storage procedure used in these tests is described as follows. Cells were first charged to 4.4 or 4.5 V and discharged to 2.8 V two times. Then the cells were charged to 4.4 or 4.5 V at a current of C/20 (11 mA) and then held at 4.4 or 4.5 V until the measured current decreased to C/1000. A Maccor series 4000 cycler was used for the preparation of the cells prior to storage. After the pre-cycling process, cells were carefully moved to the storage system which monitored their open circuit voltage every 6 hours. Storage experiments were made at 40+0.1° C. for a total storage time of 500 h or 60+0.1° C. for a total storage time of 350 h in the case of NMC442/graphite cells or 500 h in the case of NMC532/graphite cells. The voltage drop, impedance, and cell volume were measured before and after storage.

### Long-term Cycling Test

Long term cycling was conducted at 4.2 V and 4.4 V. NMC111/graphite cells were charged and discharged at 80 mA between 2.8 and 4.2V while NMC442/graphite cells were cycled between 2.8 and 4.4 V at 55.±0.1° C. using a Neware (Shenzhen, China) charger system. Capacityretention, impedance rise, and cell volume increase were measured after 500 cycles.

### Measurement of Voltage Drop on Storage

The open circuit voltage of Li-ion pouch cells was measured before and after storage at either 60° C. for 350 hours or 40° C. for 500 hours. The voltage drop (ΔV) is described in the equation 1.

ΔV=Voltage before storage−Voltage after storage eqn. 1

### Electrochemical Impedance Spectroscopy

Electrochemical impedance spectroscopy (EIS) measurements were conducted on NMC/Graphite pouch cells before and after storage. Cells were charged or discharged to 3.80 V before they were moved to a 10.0±0.1° C. temperature box. AC impedance spectra were collected with ten points per decade from 100 kHz to 10 mHz with a signal amplitude of 10 mV at 10.0±0.1° C. The impedance rise (ohms) recorded in Table 3 was calculated according to the following equation:

ΔR=Impedance after storage−Impedance before storage eqn. 2

### Determination of Gas Evolution

Ex-situ (static) gas measurements were used to measure gas evolution during formation and during cycling. The measurements were made using Archimedes' principle with cells suspended from a balance while submerged in liquid. The changes in the weight of the cell suspended in fluid, before and after testing are directly related to the change in cell volume due to the impact on buoyant force. The change in mass of a cell, Δm, suspended in a fluid of density, ρ, is related to the change in cell volume, Δv, by

Δv=−Δm/ρ eqn. 3

Ex-situ measurements were made by suspending pouch cells from a fine wire “hook” attached under a Shimadzu balance (AUW200D). The pouch cells were immersed in a beaker of de-ionized “nanopure” water (18.2 MΩ·cm) that was at 20±1° C. for measurement.

### Comparative Examples 1-8 and Examples 1-20

The additives shown in Table 1 were added to the formulated electrolyte stock solution containing 1.0M LiPF₆ in EC:EMC 3:7 by wt., as described in Table 2. These electrolytes were then used in the lithium ion pouch cells containing the NMC cathode and graphite anode.

TABLE 2
Additives added to Formulated Electrolyte Stock Solution

| | Additive and Loading |
|---|---|
| Examples | (wt % additive in formulated electrolyte) |
| Comparative | None |
| example 1 | |
| Comparative | 2% vinylene carbonate (VC) |
| example 2 | |
| Comparative | 1% Boron trifluoride diethyl etherate (1:1) |
| example 3 | |
| Comparative | 2% Boron trifluoride diethyl etherate (1:1) |
| example 4 | |
| Comparative | 1% Boron trifluoride dimethyl carbonate (1:1) |
| example 5 | |
| Comparative | 2% Boron trifluoride dimethyl carbonate (1:1) |
| example 6 | |
| Comparative | 2% Prop-1-ene,1,3-sultone (PES) |
| example 7 | |
| Comparative | 2% Triallyl phosphate (TAP) |
| example 8 | |
| Example 1 | 0.5% Boron Trifluoride Pyridine (1:1) |
| Example 2 | 1% Boron Trifluoride Pyridine (1:1) |
| Example 3 | 1.5% Boron Trifluoride Pyridine (1:1) |
| Example 4 | 1% Boron Trifluoride 2,6-Lutidine (1:1) |
| Example 5 | 0.5% Boron Trifluoride Pyrazine (2:1) |
| Example 6 | 0.5% Boron Trifluoride 1,4- |
| | Diazabicyclo[2.2.2]octane (2:1) |
| Example 7 | 1% Boron Trifluoride 4- |
| | Dimethylaminopyridine (1:1) |
| Example 8 | 1% Boron Trifluoride 1,8- |
| | Diazabicycloundec-7-ene (1:1) |
| Example 9 | 1% Boron Trifluoride Tributylamine (1:1) |
| Example 10 | 1% Phosphorus Pentafluoride Pyridine (1:1) |
| Example 11 | 1% Boron Trifluoride 4-Vinylpyridine (1:1) |
| Example 12 | 1% Boron Trifluoride 2-Fluoropyridine (1:1) |
| Example 13 | 1% Boron Trifluoride 3,4-Lutidine (1:1) |
| Example 14 | 2% Boron Trifluoride Pyridine (1:1) |
| Example 15 | 2% Boron Trifluoride 3-Fluoropyridine (1:1) |
| Example 16 | 2% Boron Trifluoride 4- |
| | (trifluoromethyl) pyridine (1:1) |
| Example 17 | 2% Boron Trifluoride 3,4-Lutidine (1:1) |
| Example 18 | 2% Boron Trifluoride 4-Vinylpyridine (1:1) |
| Example 19 | 2% Boron Trifluoride 2-Fluoropyridine (1:1) |
| Example 20 | 2% Boron Trifluoride 4-Cyanopyridine (1:1) |
| Example 21 | 2% Phosphorus Pentafluoride Pyridine (1:1) |

Lithium ion pouch cells containing the NMC442 cathode and graphite anode were stored at 4.4V and at 60° C., as described above. The voltage drop, impedance rise, and gas evolution results are summarized in Table 3. The data clearly indicates that electrolyte containing Lewis acid:Lewis base complexes of the invention as electrolyte additives reduce voltage drop, impedance rise and gas generation upon storage at high temperature and high voltage.

TABLE 3
NMC442/Graphite Cell Performance Metrics
upon Storage at 60° C. and 4.4 V

| | Voltage drop | Impedance Rise | Δ Gas volume |
|---|---|---|---|
| Electrolyte | (V) | (Ohm) | (mL) |
| Comparative | 0.17 | 0.34 | 0.63 |
| example 1 | | | |
| Example 2 | 0.14 | 0.24 | 0.40 |
| Example 4 | 0.17 | 0.11 | 0.48 |
| Example 5 | 0.17 | 0.10 | 0.38 |
| Example 6 | 0.15 | 0.25 | 0.22 |
| Example 7 | 0.14 | 0.11 | 0.54 |
| Example 8 | 0.16 | 0.21 | 0.46 |
| Example 9 | 0.09 | 0.07 | 0.29 |
| Example 10 | 0.10 | 0.07 | 0.07 |

Lithium ion pouch cells containing the NMC442 cathode and graphite anode were stored at 4.4V and at 40° C., as described above. The voltage drop results are summarized in Table 4. The data clearly indicates that electrolyte containing Lewis acid:Lewis base complexes of the invention as electrolyte additives reduce voltage drop, impedance rise and gas generation upon storage at high temperature and high voltage.

TABLE 4
NMC442/Graphite Cell Performance Metrics
upon Storage at 40° C. and 4.4 V

| | Voltage drop | Impedance Rise | Δ Gas volume |
|---|---|---|---|
| Electrolyte | (V) | (Ohm) | (mL) |
| Comparative | 0.16 | 0.14 | 0.015 |
| example 3 | | | |
| Comparative | 0.24 | 0.26 | 0.034 |
| example 4 | | | |
| Comparative | 0.20 | 0.08 | 0.027 |
| example 5 | | | |
| Comparative | 0.22 | 0.57 | 0.174 |
| example 6 | | | |
| Example 2 | 0.12 | 0.12 | −0.003 |
| Example 3 | 0.11 | 0.05 | −0.004 |
| Example 11 | 0.12 | 0.01 | −0.006 |
| Example 12 | 0.13 | −0.10 | 0.003 |
| Example 13 | 0.11 | −0.07 | −0.004 |

Table 5 shows ultra-high precision cycling data for NMC442/graphite pouch cells cycled at 40° C. and 4.4V. Electrolyte containing the additives disclosed in this invention provide comparable or better performance with respect to coulombic efficiency (CE), charge endpoint capacity slippage, gas volume change, and charge transfer impedance rise compared to comparative example 2 (with 2% VC additive).

TABLE 5
NMC442/Graphite Cell Performance Metrics
upon UHPC cycling at 40° C. and 4.4 V

| | | Charge slippage | Δ Gas volume | □R_{ct} |
|---|---|---|---|---|
| Electrolyte | CE | (mAh/cycle) | (mL) | (Ohm) |
| Comparative | 0.9973 | 0.31 | 0.03 | 4.19 |
| example 2 | | | | |
| Example 2 | 0.9982 | 0.29 | 0.04 | 1.21 |
| Example 3 | 0.9983 | 0.30 | 0.05 | 0.48 |
| Example 11 | 0.9981 | 0.28 | 0.02 | 0.83 |
| Example 12 | 0.9981 | 0.34 | 0.04 | 0.37 |
| Example 13 | 0.9977 | 0.36 | 0.05 | 0.41 |

NMC442/graphite pouch cells were cycled at 55° C. and 4.4V. Table 6 shows the capacity retention, impedance rise, and cell volume increase on long term cycling test. Obviously all the cells with additives disclosed in this invention showed better cycling performance than the comparative example 8 (with 2% TAP additive).

TABLE 6
NMC442/Graphite Cell Performance Metrics
upon Long-term Cycling at 55° C. and 4.4 V

| | Capacity | Impedance Rise | Δ Gas Volume |
|---|---|---|---|
| Electrolyte | retention % | (Ohm) | (mL) |
| Comparative | 52.1 | 3.65 | 0.35 |
| example 8 | | | |
| Example 14 | 73.7 | −0.21 | 0.24 |
| Example 15 | 68.4 | 0.11 | 0.22 |
| Example 16 | 67.6 | 1.01 | 0.16 |
| Example 17 | 65.5 | 0.96 | 0.33 |
| Example 18 | 65.3 | 1.65 | 0.18 |
| Example 19 | 65.1 | 0.21 | 0.20 |
| Example 20 | 63.2 | 1.93 | 0.22 |

Lithium ion pouch cells containing the NMC442 cathode and graphite anode were stored at 4.5V and at 40° C., as described above. The voltage drop results are summarized in Table 7 and clearly show that electrolyte containing Lewis acid:Lewis base complexes of the invention as electrolyte additives improved the cell's storage performance at high temperature and high voltage.

TABLE 7
NMC442/Graphite Cell Performance Metrics
upon Storage at 40° C. and 4.5 V.

| | Voltage drop | Impedance Rise | Δ Gas volume |
|---|---|---|---|
| Electrolyte | (V) | (Ohm) | (mL) |
| Comparative | 0.22 | 0.45 | 0.017 |
| example 1 | | | |
| Comparative | 0.29 | 0.41 | 0.056 |
| example 3 | | | |
| Comparative | 0.26 | 0.17 | 0.027 |
| example 5 | | | |
| Comparative | 0.18 | −0.43 | 0.039 |
| example 7 | | | |
| Example 1 | 0.16 | 0.28 | −0.002 |
| Example 2 | 0.15 | 0.13 | −0.003 |
| Example 12 | 0.17 | 0.02 | 0.017 |
| Example 13 | 0.16 | 0.05 | 0.008 |

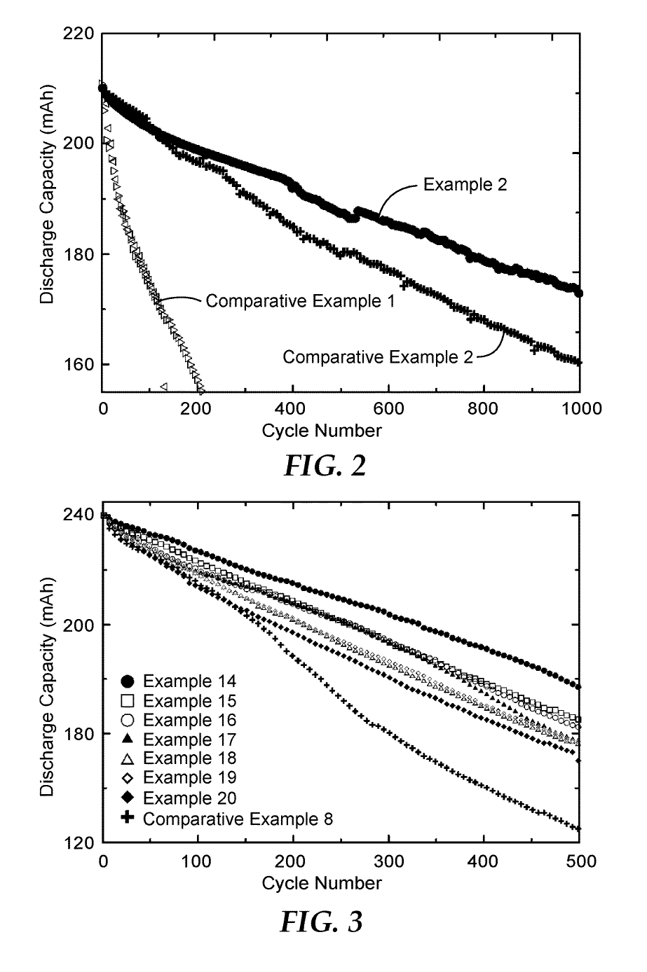

NMC11/graphite cells were charged and discharged at 80 mA between 2.8 and 4.2V at 55° C. FIG. 2 shows the discharge capacity of NMC111/graphite cells vs. cycle number during extended testing (˜6 months) at 55° C. In order to clearly compare the curves, the capacities of the cells were normalized to the same starting value (210 mAh). The actual capacities were in the range of 205 to 217 mAh. The cells with control electrolyte lost more than 20% of their initial capacity in the first 200 cycles. FIG. 2 clearly shows that example 2 significantly improved cycle life of lithium ion cells compared to comparative examples 1, and 2.

NMC442/graphite cells were cycled between 2.8 and 4.4 V at 55° C. FIG. 3 shows the discharge capacity versus cycle number of NMC442/graphite pouch cells containing different additives under extremely aggressive cycling conditions. The cells were cycled between 2.8 V and 4.4 V at 55° C. and 80 mA current (˜rate C/3) without clamps, so generated gas would promote loss of stack pressure. After 500 cycles (more than 4 months), all of these cells retained less than 80% of their initial capacity but example 14 performed best. Cells with additives disclosed in this invention showed promising long-term cycling results at high voltage (4.4V) and high temperature (55° C.) vs. comparative example 8 (with 2% TAP additive).

Lithium ion pouch cells containing the NMC532 cathode and graphite anode were stored at 4.5V and at 60° C., as described above. The voltage drop results are summarized in Table 8 and clearly show that electrolyte containing Lewis acid:Lewis base complex of the invention as electrolyte additives improved the cell's storage performance at high temperature and high voltage. The amount of gas generated under these storage conditions were also greatly reduced.

TABLE 8
NMC532/Graphite Cell Performance Metrics
upon Storage at 60° C. and 4.5 V.

| | Voltage Drop | Impedance Rise | Δ Gas Volume |
|---|---|---|---|
| Electrolyte | (V) | (Ohm) | (mL) |
| Comparative | 0.42 | 85 | 0.66 |
| Example 1 | | | |
| Example 22 | 0.24 | 84 | 0.13 |

Electrochemical Cell Preparation with Si Alloy Anodes.

Dry pouch cells (200 mAh) were obtained without electrolyte from Li-Fun Technology Corporation (Xinma Industry Zone, Golden Dragon Road, Tianyuan District, Zhuzhou City, Hunan Province, PRC, 412000, China). The electrode composition in the cells was as follows: Positive electrode−96.2%:1.8%:2.0%=LiCoO₂:Carbon Black:PVDF Binder; Negative electrode−17.2%:62.8%:10%:10%=Si alloy (C7-6W34, 3M Company):graphite (MAGE, Hitachi Chemical):conductive carbon (KS6L, Timcal):binder (250 k LiPAA). The positive electrode coating had a thickness of 93 μm. The negative electrode coating had thickness of 44 μm, a loading of 6.6 mg/cm² and was calendered to 30% porosity. The positive electrode dimensions were 187 mm×26 mm and the negative electrode dimensions were 191 mm×28 mm. These cells are referred to as LiFunSi-v1

Another batch of dry pouch cells (200 mAh) were obtained from Li-Fun Technology. They were identical to the LiFunSi-v1 cells except that the negative electrode formulation was changed to 15%:72.3%:10%:1.5%:1.2%=Si alloy (C7-4A36, 3M Company):graphite (MAGE, Hitachi Chemical):conductive carbon (KS6L, Timcal):SBR (X3, Zeon):CMC (2200, Diacell). These are referred to as LiFunSi-v2.

Both electrodes were coated on both sides, except for small regions on one side at the end of the foils. All pouch cells were vacuum sealed without electrolyte in China. Before electrolyte filling, the cells were cut just below the heat seal and dried at 80° C. under vacuum for at least 14 h to remove any residual water in a dry room with a dew point of −40° C. While still in the dry room, the cells were filled with electrolyte and vacuum sealed. All pouches were filled with 0.65 mL of electrolyte. After filling, cells were vacuum-sealed with a vacuum sealer (MSK-115A, MTI Corp.). First, cells were charged to 2V then let to rest open circuit for 12 h, then charged ot 2V again then left to rest for 12 h. The cells were then charged at 10 mA (C/20) up to 3.8 V, taken to the dry room, cut open to release gas generated and then vacuum sealed again. The cells were then charged at 10 mA (C/20) up to 4.35 V and discharged to 2.75 V at 10 mA (C/20). This formation was performed at the same temperature as the subsequent cycling. Either room temperature (22° C. or 45° C.).

### Room Temperature Cycling of Si Alloy Cells

The LiFunSi-v1 cells were cycled with a Neware BTS4000 cycler in a temperature controlled room at 22±2° C. After the formation cycle described above the cells were charged a 100 mA (C/2) up to 4.35 V and held at 4.35 V until the current dropped to 10 mA (C/20), left to rest open circuit for 15 minutes, then discharged at 100 mA (C/2) until the voltage reached 2.75 V, and then left to rest open circuit for 15 minutes. This cycling was repeated and every 50 cycles a slow cycle was performed which consisted in charging at 10 mA (C/20) up to 4.35 V, resting 15 minutes, discharging at 10 mA down to 2.75 V and resting 15 minutes. This cycling procedure was performed for at least 200 cycles. Table 9 lists the additives used in the electrolytes. The electrolytes were formulated using the additive listed, 10% FEC, and the remainder EC/EMC 3/7 with 1M LiPF₆.

TABLE 9
Prepared Electrolytes for Evaluation in Si Alloy Cells

| | Additive |
|---|---|
| Comparitive | None |
| Example 9 | |
| Example 22 | 2% Pentafluoro Phosphate Pyridine (1:1) |
| Example 23 | 2% Boron Trifluoride Pyridine (1:1) |

The performance of the cells is quantified by the capacity retention after 200 cycles. Table 10 lists the performance of the cells and shows that the additives have resulted in improved cycling.

TABLE 10
Discharge Retention Data For Si Alloy
Cells With Room Temperature Cycling

| | | Cycle 1 | Cycle 200 | |
|---|---|---|---|---|
| | | Discharge | Discharge | Retention |
| | | Capacity | Capacity | (Cycle 200/ |
| | Cell ID | (mAh) | (mAh) | Cycle 1) |
| Comparitive | 32008p1c | 210 | 169 | 80.5% |
| Example 9 | | | | |
| Example 23 | 32604p2c | 203 | 170 | 83.9% |
| Example 24 | 32627p2b | 199 | 166 | 83.5% |

### High Temperature, High Precision Cycling for Si Alloy Cells

The LiFunSi-v2 cells were filled as described above with the electrolytes and additives listed in Table 11 and the remainder EC/EMC 3/7 with 1M LiPF₆. The cells were formed and cycled on an ultra high precision cycler model UHPCv1 (Novonix, Halifax, NS, Canada) in a temperature controlled chamber held at 45+0.1° C. The cells were cycled by charging at 20 mA (C/10) up to 4.35V, resting open circuit for 15 minutes, discharging at 20 mA down to 2.75 V, and resting open circuit for 15 minutes. At least 40 cycles were performed.

TABLE 11
Electrolyte Preparation for High Temperature,
High Precision Cycling for Si Alloy Cells

| | | Electrolytes, |
|---|---|---|
| | Cell ID | Additives |
| Comparitive | 32902p[12] | 10% FEC |
| Example 10 | | |
| Example 24 | 32903p[12] | 10% FEC, 2% Boron |
| | | Trifluoride Pyridine (1:1) |
| Example 25 | 32904p[12] | 5% FEC, 2% Boron |
| | | Trifluoride Pyridine (1:1) |
| Example 26 | 32905p[12] | 2% FEC, 5% Boron |
| | | Trifluoride Pyridine (1:1) |

Table 12 shows the CE, capacity and retention. The samples with the Lewis Complex additives show better CE and capacity retention.

TABLE 12
Data for Si Alloy Cells

| | | CE | | | |
|---|---|---|---|---|---|
| | | (average | Cycle 1 | Cycle 40 | Retention |
| | | cycles | Capacity | Capacity | (Cycle 40/ |
| | CellID | 35-40) | (mAh) | (mAh) | Cycle 1) |
| Comparitive | 32902p2c | 0.9960 | 215.1 | 177.6 | 82.6% |
| Example 10 | | | | | |
| Example 24 | 32903p2c | 0.9966 | 214.1 | 192.0 | 89.7% |
| Example 25 | 32904p2c | 0.9965 | 213.3 | 190.1 | 89.1% |
| Example 26 | 32905p1c | 0.9962 | 199.6 | 176.0 | 88.2% |

After at least 40 cycles, the cells were taken out of the cycler. The Counter Example Si2 cells had gassed sufficiently to build an internal gas pressure greater than the ambient atmospheric pressure. Examples Si3 through Si5 on the other hand had maintained their original appearance.

The Lewis Complex additives therefore provide significant benefits in combination with Si alloy materials including increased capacity retention and improved coulombic efficiency. Furthermore added benefits are obtained in combination with fluoroethylene carbonate (FEC), in addition to increased capacity retention and improved coulombic efficiency, the Lewis Complex additives suppress gassing.

The dry pouch cells (200 mAh) which were obtained from Li-Fun Technology, referred to as LiFunSi-v2, were used in the Table 13. The negative electrode formulation was 15%:72.3%:10%:1.5%:1.2%=Si alloy (C7-4A36, 3M Company):graphite (MAGE, Hitachi Chemical):conductive carbon (KS6L, Timcal):SBR (X3, Zeon):CMC (2200, Diacell). The cathode is 96.2%:1.8%:2.0%=LiCoO₂:Carbon Black:PVDF Binder. Before electrolyte filling, the pouch cells were cut open and dried at 80° C. under vacuum for at least 14 h to remove any residual water in a dry room with a dew point of −40° C. While still in the dry room, the cells were filled with electrolyte and vacuum sealed. All pouches were filled with 0.65 mL of electrolyte. After filling, cells were vacuum-sealed with a vacuum sealer (MSK-115A, MTI Corp.). The base electrolyte is LiPF₆/PC/EC/DEC=13 wt %/25 wt %/25 wt %/37 wt %. (PC=Propylene carbonate; EC=Ethylene carbonate; DEC=Diethyl carbonate). The additives as in the following Table 13 were added into the base electrolyte respectively and reduce the relative content of DEC in order to be sure the total sum to be 100%. (FEC=fluoroethylene carbonate; DFEC=difluoroethylene carbonate; MMDS=1,5,2,4-dioxadithiane-2,2,4,4-tetraoxide; TAP=triallyl phosphate; PyBF3=Boron Trifluoride Pyridine (1:1); PyPF5=Phosphorus Pentafluoride Pyridine (1:1); HQ115=LiN(SO₂CF₃)₂, from 3M). The pouch cells containing the electrolyte as in the following table were charged to 3.9V at room temperature with C/20 and hold at 3.9V till the charge current decades down to C/40. (1C=200 mAh). These are called formation step 1 (FM1). The pouch cell volume variation before FM1 and post FM1 are the volume of produced gas during FM1 (FM1_produced_Gas). (Detail measurement is described in the section “Determination of Gas Evolution”).

TABLE 13
The electrolyte type and produced gas volume
of Si pouch cell during formation step 1.

| Sample | | | FM1_produced_GAS |
|---|---|---|---|
| List | EL # | Additives | (mL) |
| Comp. | AE32 | 2% MMDS/2% PyPFS | 7.22 |
| Ex11 | | | |
| Comp. | AE23 | 2% MMDS/2% PyBF3 | 6.08 |
| Ex12 | | | |
| Comp. | AE34 | 2% TAP/2% PyPF5 | 5.97 |
| Ex13 | | | |
| Comp. | AE29 | 2% TAP/2% PyBF3 | 5.25 |
| Ex14 | | | |
| Comp. | AE30 | No additives | 5.15 |
| Ex15 | | | |
| Ex. 27 | AE33 | 5% FEC/2% PyPF5 | 0.18 |
| Ex. 28 | AE20 | 5% FEC/2% MMDS/2% | 0.18 |
| | | TAP/2% PyBF3 | |
| Ex. 29 | AE35 | 5% FEC/2% MMDS/2% | 0.17 |
| | | TAP | |
| Ex. 30 | AE24 | 5% FEC/2% PyBF3 | 0.16 |
| Ex. 31 | AE31 | 5% FEC/2% MMDS/2% | 0.16 |
| | | PyPF5 | |
| Ex. 32 | AE21 | 5% FEC/2% MMDS/2% | 0.16 |
| | | TAP/2% PyBF3/4% HQ-115 | |
| Ex. 33 | AE22 | 5% FEC/2% MMDS/2% | 0.16 |
| | | PyBF3 | |
| Ex. 34 | AE05 | 5% FEC/2% MMDS/2% | 0.04 |
| | | TAP/2% PyPF5 | |

From the above table 13, it is clear that Silicon pouch cells containing of additives of PyBF3, PyPF5, MMDS and TAP, without FEC, produced huge amount of gas. With FEC in, the produced gas is dramatically less. In another word, The additives of PyBF3, PyPF5, MMDS and TAP will work well with FEC.

The dry pouch cells (200 mAh) which were obtained from Li-Fun Technology, referred to as LiFunSi-v2 were also used to evaluate the electrolyte in the Table 14. After dried pouch cell were filled with the electrolyte as in Table 14, they were vacuum-sealed with a vacuum sealer (MSK-115A, MTI Corp.). After passing Formation Step 1 (FM1) at room temperature, the cells were sandwiched with two plates under suitable pressure and aged at 70° C. for four hours. Then cells were cut open and vacuum-sealed again to remove the produced gas (degassing). Then cells were trickle charge to 4.35V using C/20 current till the current decades down to C/40 at room temperature, then discharge to 2.8V. At last, the cells were degassed and vacuum-sealed again.

After formation, the cells were charged with a 100 mA (C/2) up to 4.35 V and held at 4.35 V until the current dropped to 10 mA (C/20), left to rest open circuit for 15 minutes, then discharged at 200 mA (1C) until the voltage reached 3.0 V, and then left to rest open circuit for 15 minutes. This cycling procedure was performed for at least 500 cycles. The test was at room temperature. The capacity at cycle 5 and cycle 200 were shown in Table 14.

It is clear that when total amount of FEC and DFEC were about 10 wt % or 15%, the cells show best capacity retention. When the amount of FEC and DFEC is only 5 wt %, or 20%, the performances are dramatically worse.

TABLE 14
The electrolyte type and capacity retention of the Si pouch cell

| | | | Cycle | Cycle | Retention |
|---|---|---|---|---|---|
| Sample | | | 5 | 200 | (Cycle 200/ |
| List | Additives | Cell_Id | (mAh) | (mAh) | Cycle 5) |
| Comp. | 2% MMDS/2% | 42AE37 | 177.9 | 100.6 | 56.5% |
| Ex 16 | TAP 2% | | | | |
| | PyPF5/5% FEC | | | | |
| Ex. 35 | 2% MMDS/2% | 43AE38 | 171.6 | 146.7 | 85.5% |
| | TAP 2% | | | | |
| | PyPF5/5% | | | | |
| | FEC/5% DFEC | | | | |
| Ex. 36 | 2% MMDS/2% | 44AE39 | 168.9 | 145.6 | 86.2% |
| | TAP 2% | | | | |
| | PyPF5/10% | | | | |
| | FEC/5% DFEC | | | | |
| Comp. | 2% MMDS/2% | 45AE40 | 156.2 | 108.0 | 69.1% |
| Ex. 17 | TAP 2% | | | | |
| | PyPF5/10% | | | | |
| | FEC/10% DFEC | | | | |

1. An electrolyte solution comprising:
a solvent;
an electrolyte salt; and
a LA:LB complex represented by the following general formula I:
[(FₙA)ₓ-L] (I)
where A is boron or phosphorous,
F is fluorine,
L is an aprotic organic amine,
n is 3 or 5,
when n=3, A is boron, and when n=5, A is phosphorous,
x is an integer from 1-3, and
at least one N atom of the aprotic organic amine, L, is bonded directly to A, and
wherein the LA:LB complex is present in the solution in an amount of between 0.01 and 5.0 wt. %, based on the total weight of the electrolyte solution.

2. The electrolyte solution of claim 1, wherein the aprotic organic amine comprises at least one nitrogen atom with a non-bonding electron pair that is available for bonding with an empty orbital of the Lewis acid.

3. The electrolyte solution according to claim 1, wherein the aprotic organic amine comprises a tertiary amine.

4. The electrolyte solution according to claim 1, wherein the aprotic organic amine comprises a heteroaromatic amine.

5. The electrolyte solution according to claim 1, wherein excess Lewis acid or Lewis base is present in the electrolyte solution at less than 5 mol % based on the stoichiometry of general formula I.

6. The electrolyte solution according to claim 1, wherein the solvent comprises an organic carbonate.

7. The electrolyte solution according to claim 1, wherein the solvent comprises ethylene carbonate, diethyl carbonate, dimethyl carbonate, ethyl methyl carbonate, vinylene carbonate, propylene carbonate, fluoroethylene carbonate, tetrahydrofuran (THF), gamma butyrolactone, sulfolane, ethyl acetate, or acetonitrile.

8. The electrolyte solution according to claim 1, wherein the solvent is present in the solution in an amount of between 15 and 98 wt. %, based on the total weight of the electrolyte solution.

9. The electrolyte solution according to claim 1, wherein the electrolyte salt comprises a lithium salt.

10. The electrolyte solution according to claim 1, wherein the electrolyte salt comprises LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), or LiN(SO₂F)(SO₂C₄F₉).

11. The electrolyte solution according claim 1, wherein the electrolyte salt is present in the solution in an amount of between 5 and 75 wt. %, based on the total weight of the electrolyte solution.

12. The electrolyte solution according to claim 1, further comprising vinylene carbonate, fluoroethylene carbonate, propane-1,3-sultone, prop-1-ene-1,3-sultone, succinonitrile, 1,5,2,4-dioxadithiane-2,2,4,4-tetraoxide (MMDS), lithium bis(oxalate)borate (LiBOB), lithium difluoro(oxalato)borate (LiDFOB), tris(trimethylsilyl)phosphite (TTSPi), ethylene sulfite (ES), 1,3,2-dioxathiolan-2,2-oxide (DTD), vinyl ethylene carbonate (VEC), trimethylene sulfite (TMS), methyl phenyl carbonate, tri-allyl-phosphate (TAP), ethyl phenyl carbonate (EPC), diphenyl carbonate (DPC) and tris(trimethylsilyl)phosphate (TTSP).

13. A method of making an electrolyte solution, the method comprising:
combining a solvent, an electrolyte salt, and a LA:LB complex;
wherein the LA:LB complex is represented by the following general formula:
[(FₙA)ₓ-L]
where A is boron or phosphorous,
F is fluorine,
L is an aprotic organic amine,
n is 3 or 5,
when n=3, A is boron, and when n=5, A is phosphorous,
x is an integer from 1-3, and
wherein at least one N atom of the aprotic organic amine, L, is bonded directly to A, and
wherein the LA:LB complex is present in the solution in an amount of between 0.01 and 5.0 wt %, based on the total weight of the electrolyte solution.

14. An electrochemical cell comprising:
a positive electrode;
a negative electrode; and
an electrolyte solution according to claim 1.

15. The electrochemical cell according to claim 14, wherein the positive electrode comprises an active material, the active material comprising a lithium metal oxide or a lithium metal phosphate.

16. The electrochemical cell according to claim 1, wherein the negative electrode comprises an active material, the active material comprising lithium metal, a carbonaceous material, or a metal alloy.

17. An electrolyte solution comprising:
a solvent;
an electrolyte salt; and
a LA:LB complex represented by the following general formula:
[(FₙA)ₓ-L]
where A is boron or phosphorous,
F is fluorine,
L is an aprotic heteroaromatic amine,
n is 3 or 5,
when n=3, A is boron, and when n=5, A is phosphorous,
x is an integer from 1-3, and
wherein at least one N atom of the aprotic heteroaromatic amine, L, is bonded directly to A.
